(19) United States
(12) Patent Application Publication
(10) Pub. No.: US 2020/0134111 A1
(43) Pub. Date: Apr. 30, 2020

(54) SIMULATION APPARATUS, SIMULATION METHOD, AND COMPUTER READABLE MEDIUM STORING PROGRAM

(71) Applicant: SUMITOMO HEAVY INDUSTRIES, LTD., Tokyo (JP)

(72) Inventors: Yoshitaka Ohnishi, Kanagawa (JP); Shuji Miyazaki, Kanagawa (JP)

(21) Appl. No.: 16/566,334

(22) Filed: Sep. 10, 2019

(30) Foreign Application Priority Data
Oct. 30, 2018 (JP) 2018-204194

(51) Int. Cl. G06F 17/50

(52) U.S. Cl. CPC G06F 17/5009; G06F 2217/16

(57) ABSTRACT

A value of a parameter defining a linear term and a value of a parameter defining a nonlinear term of an interaction potential between particles determined according to a material to be simulated and an initial condition of a particle disposition are input to an input unit. A processing unit analyzes behavior of the particles by a molecular dynamics method using the interaction potential defined by the values of the parameters input to the input unit and based on the initial condition input to the input unit.

### RELATED APPLICATIONS

The content of Japanese Patent Application No. 2018-204194, on the basis of which priority benefits are claimed in an accompanying application data sheet, is in its entirety incorporated herein by reference.

### BACKGROUND

### Technical Field

Certain embodiment of the present invention relates to a simulation apparatus, a simulation method, and a computer readable medium storing a program.

### Description of Related Art

There is a known simulation method of analyzing deformation when external force is applied to a material having a random shape by a molecular dynamics method or a renormalization group molecular dynamics method (for example, Patent Document 1). Hereinafter, in the present specification, the molecular dynamics method and the renormalization group molecular dynamics method are collectively and simply referred to as a molecular dynamics method.

In the simulation method based on the molecular dynamics method, it is possible to analyze an elastic region using a model in which a material to be simulated is represented by an aggregate of a plurality of particles and the particles are coupled by a spring. A spring constant of the spring that couples the particles is determined such that a Young's modulus of the material is reproduced regardless of a particle disposition based on a Voronoi area derived from tetra mesh information with positions of the plurality of particles as nodes.

### Patent Document 1

Japanese Unexamined Patent Publication No. 2009-37334

### SUMMARY

According to an embodiment of the present invention, there is provided a simulation apparatus including: an input unit that acquires a value of a parameter defining a linear term and a value of a parameter defining a nonlinear term of an interaction potential between particles determined according to a material to be simulated and an initial condition of a particle disposition; and a processing unit that analyzes behavior of the particles by a molecular dynamics method based on the initial condition acquired by the input unit, using the interaction potential defined by the values of the parameters acquired by the input unit.

According to another aspect of the invention, there is provided a simulation method including: analyzing behavior of particles by a molecular dynamics method using an interaction potential defined by a value of a parameter defining a linear term and a value of a parameter defining a nonlinear term of the interaction potential between the particles determined according to a material to be simulated, as a simulation condition.

According to yet another aspect of the invention, there is provided a computer readable medium storing a program that causes a computer to execute a process. The process includes a function of analyzing behavior of particles by a molecular dynamics method using an interaction potential defined by a value of a parameter defining a linear term and a value of a parameter defining a nonlinear term of the interaction potential between the particles determined according to a material to be simulated, as a simulation condition.

### BRIEF DESCRIPTION OF THE DRAWINGS

FIG. 1 is a block diagram of a simulation apparatus according to an embodiment.

FIG. 2 is a schematic diagram showing a particle i, a particle j, and a part of a Voronoi polyhedron near both particles.

FIG. 3 is a graph showing a shape of an interaction potential.

FIG. 4A is a perspective view of a simulation model, and FIG. 4B is a graph showing a relationship between an applied stress and a strain obtained by a simulation.

FIG. 5 is a perspective view of three simulation models having different dimensions.

FIGS. 6A and 6B are graphs showing a relationship between the strain and the stress of each model when an analysis is performed using an interaction potential with nonlinear parameters a₃=a₄=0, FIG. 6C is a graph showing a simulation result when a₃=−5 and a₄=−1, and FIG. 6D is a graph showing a simulation result when a₃=−10 and a₄=20.

FIG. 7 is a flowchart of a procedure for finding optimum values of parameters A, a₃, and a₄.

FIG. 8A is a graph showing an example of first stress-strain relationship data, and FIG. 8B is a graph showing a relationship between a Young's modulus and a strain ε obtained from the first stress-strain relationship data.

FIG. 9 is a scatter diagram with a determination coefficient of a Young's modulus-strain relationship as a horizontal axis and a determination coefficient of a stress-strain relationship as a vertical axis.

FIG. 10A is a graph showing second stress-strain relationship data obtained by a molecular dynamics method with parameters A, a₃, and a₄ set to optimum values and first stress-strain relationship data obtained from measured values, and FIG. 10B is a graph showing second Young's modulus-strain relationship data obtained by the molecular dynamics method with parameters A, a₃, and a₄ set to optimum values and first Young's modulus-strain relationship data obtained from measured values.

FIG. 11 is a flowchart of a simulation method according to the embodiment.

### DETAILED DESCRIPTION

In the analysis of the linear elastic material, the spring constant of the spring that couples the particles can be determined by a known method. In the simulation method in the related art of determining the spring constant by this method, it is impossible to perform a simulation such as deformation of the nonlinear elastic material.

There is a need for providing a simulation apparatus, a simulation method, and a computer readable medium storing a program capable of performing a simulation such as deformation of a nonlinear elastic material.

Next, a simulation apparatus and a simulation method according to an embodiment will be described with reference to FIGS. 1 to 11.

FIG. 1 is a block diagram of the simulation apparatus according to the embodiment. The simulation apparatus according to the embodiment includes an input unit 20, a processing unit 21, an output unit 22, and a storage unit 23. A simulation condition and the like are input from the input unit 20 to the processing unit 21. Further, various commands are input from an operator to the input unit 20. The input unit 20 is formed of, for example, a communication apparatus, a removable media reading apparatus, and a keyboard.

The processing unit 21 performs a simulation by a molecular dynamics method based on the input simulation condition and outputs a simulation result to the output unit 22. The simulation result includes information representing behavior of particles when a simulation target is represented by an aggregate of a plurality of particles. The processing unit 21 includes, for example, a computer, and a program for causing the computer to execute a simulation by the molecular dynamics method is stored in the storage unit 23. The output unit 22 includes a communication apparatus, a removable media writing apparatus, a display, and the like.

In this embodiment, in order to simulate deformation of a nonlinear elastic material, a nonlinear term is introduced into an interaction potential between the particles used in the molecular dynamics method. Hereinafter, a method of introducing the nonlinear term of the interaction potential will be described.

An interaction potential φ(rᵢⱼ) between a particle i and a particle j is represented by the following equation.

[Formula 1]

ϕ(rᵢⱼ)=½kᵢⱼ(rᵢⱼ−rᵢⱼ₀)² (1)

Here, kᵢⱼ is a spring constant of a spring that couples the particles i and j, rᵢⱼ is a distance between the particles i and j, and rᵢⱼ₀ is a distance between the particles i and j when the spring has a natural length.

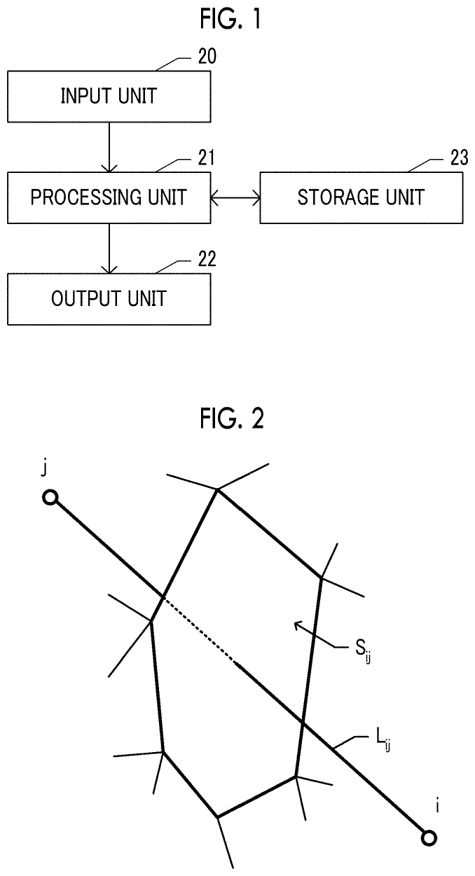

Next, a method of determining the spring constant kᵢⱼ will be described with reference to FIG. 2. The method of determining the spring constant kᵢⱼ is described in detail in the above Patent Document 1 and thus will be briefly described here. First, a tetra mesh is generated based on a three-dimensional shape to be simulated. The particle is disposed at a node of the tetra mesh and a Voronoi polyhedron analysis is performed.

FIG. 2 is a schematic diagram showing the particle i, the particle j, and a part of a Voronoi polyhedron near both particles. An area of an interface crossing a line segment Lᵢⱼ with the particles i and j as both ends of a plurality of interfaces constituting the Voronoi polyhedron is represented by Sᵢⱼ. In a case of a linear elastic material, it is possible to determine the spring constant kᵢⱼ from a Young's modulus of the material and the area Sᵢⱼ.

In this embodiment, a nonlinear term is added to the interaction potential of equation (1), and the interaction potential is defined by the following equation (2).

[Formula 2]

ϕ(rᵢⱼ)=½kᵢⱼ(rᵢⱼ−rᵢⱼ₀)²+aᵢⱼ₃(rᵢⱼ−rᵢⱼ₀)³+aᵢⱼ₄(rᵢⱼ−rᵢⱼ₀)⁴ (2)

In Equation (2), third-order and fourth-order terms are added as the nonlinear term, but higher-order terms may be added. In this embodiment, up to the fourth-order term is considered as the nonlinear term of the interaction potential.

Coefficients aᵢⱼ₃ and aᵢⱼ₄ of the third-order term and the fourth-order term in equation (2) are defined by the following equation (3).

$$\begin{matrix}[ Formula 3 ] & \\ {a}_{ij 3} = \frac{{a}_{3}}{2 {r}_{ij 0}} {k}_{ij} & ( 3 ) \\ {a}_{ij 4} = \frac{{a}_{4}}{2 {r}_{ij 0}^{2 }} {k}_{ij} & \end{matrix}$$

In a case where a material to be handled is the linear elastic material, it is possible to determine the spring constant kᵢⱼ from the Young's modulus of the material as described with reference to FIG. 2. However, in a case where the nonlinear elastic material is handled, the Young's modulus cannot be clearly defined. Therefore, it is also impossible to determine the spring constant from the Young's modulus. A newly adjustable parameter A is added and the spring constant is defined as A·kᵢⱼ.

Further, it is assumed that the deformation when the nonlinear elastic material is compressed is substantially linear and nonlinearity appears when a tensile stress is applied to the nonlinear elastic material. When a compressive strain is generated in the nonlinear elastic material, that is, when rᵢⱼ≤rᵢⱼ₀, the interaction potential can be represented by the following equation (4).

[Formula 4]

ϕ(rᵢⱼ)=½Akᵢⱼ(rᵢⱼ−rᵢⱼ₀)² (4)

When an extending strain is generated in the nonlinear elastic material, that is, when rᵢⱼ>rᵢⱼ₀, the interaction potential can be represented by the following equation (5).

$$\begin{matrix} [ Formula 5 ] & \\ φ ( {r}_{ij} ) = A \{ \frac{1}{2} {{k}_{ij} ( {r}_{ij} - {r}_{ij 0} )}^{2} + \frac{{a}_{3}}{2 {r}_{ij 0}} {{k}_{ij} ( {r}_{ij} - {r}_{ij 0} )}^{3} + \frac{{a}_{4}}{2 {r}_{ij 0}^{2}} {{k}_{ij} ( {r}_{ij} - {r}_{ij 0} )}^{4} \} & ( 5 )\end{matrix}$$

When A=1 and a₃=a₄=0, the interaction potential of equation (5) has the same shape as the interaction potential when the linear elastic material is handled.

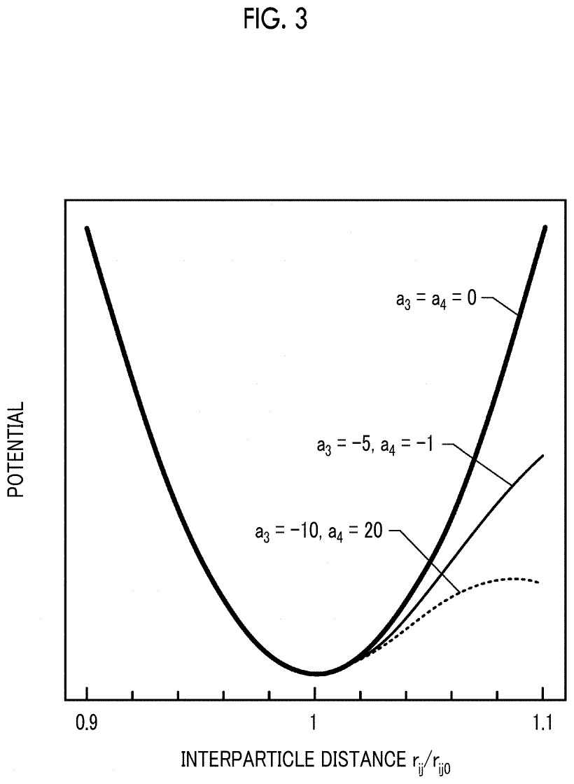

FIG. 3 is a graph showing a shape of the interaction potential. The horizontal axis represents an interparticle distance rᵢⱼ/rᵢⱼ₀ normalized by the spring natural length rᵢⱼ₀, and the vertical axis represents magnitude of the interaction potential. In the graph of FIG. 3, a thick solid line indicates the interaction potential when a₃=a₄=0, a thin solid line indicates the interaction potential when a₃=−5 and a₄=−1, and a broken line indicates the interaction potential when a₃=−10 and a₄=20. It can be understood that the nonlinearity appears in a region where the extending strain is generated in the material.

A simulation is performed to obtain the deformation of the material when a tensile test is performed using the interaction potentials of equations (4) and (5). Hereinafter, a simulation result will be described.

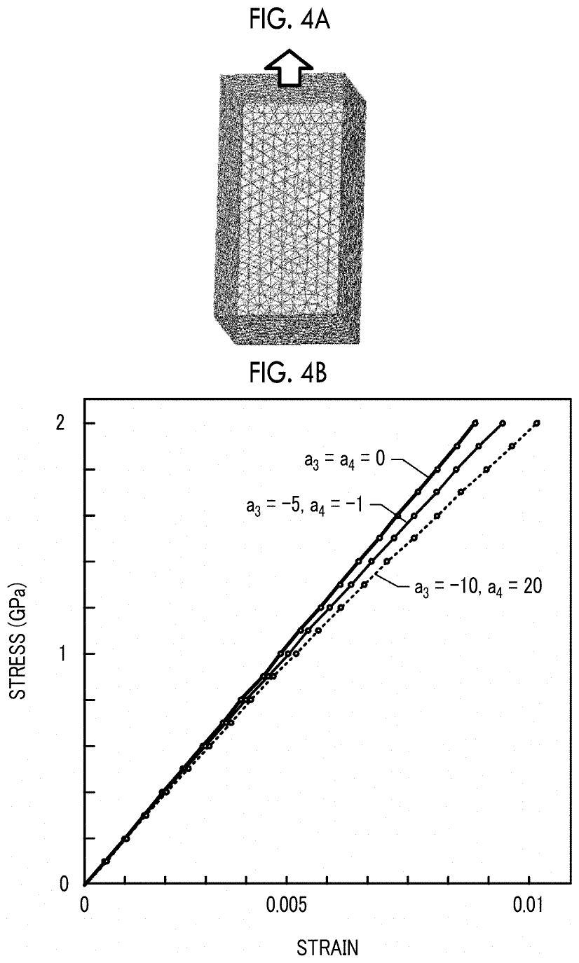

FIG. 4A is a perspective view of a simulation model. The simulation model is a rectangular parallelepiped of 10 mm, 10 mm, and 20 mm in length, width, and height, respectively. Under a condition that the bottom surface of the rectangular parallelepiped is fixed and the tensile stress is applied to the upper surface thereof, an analysis is performed until a steady state is obtained by the molecular dynamics method to obtain the strain.

FIG. 4B is a graph showing a relationship between an applied stress and a strain obtained by the simulation. The horizontal axis represents the strain, and the vertical axis represents the stress in a unit “GPa”. In the graph of FIG. 4B, the relationships between the stress and the strain are shown in a case where a thick solid line is a₃=a₄=0, a thin solid line is a₃=−5 and a₄=−1, a broken line is a₃=−10 and a₄=20, in equation (5). When a₃=a₄=0, the relationship between the stress and the strain is linear. In other cases, it is confirmed that a nonlinear relationship appears between the stress and the strain.

In a case where the simulation is performed using the interaction potential shown in equation (5), an obtained relationship between the strain and the stress is required to be the same even though the simulation model has a different dimension. Hereinafter, results of obtaining the relationships between the stress and the strain of simulation models having different dimensions will be described.

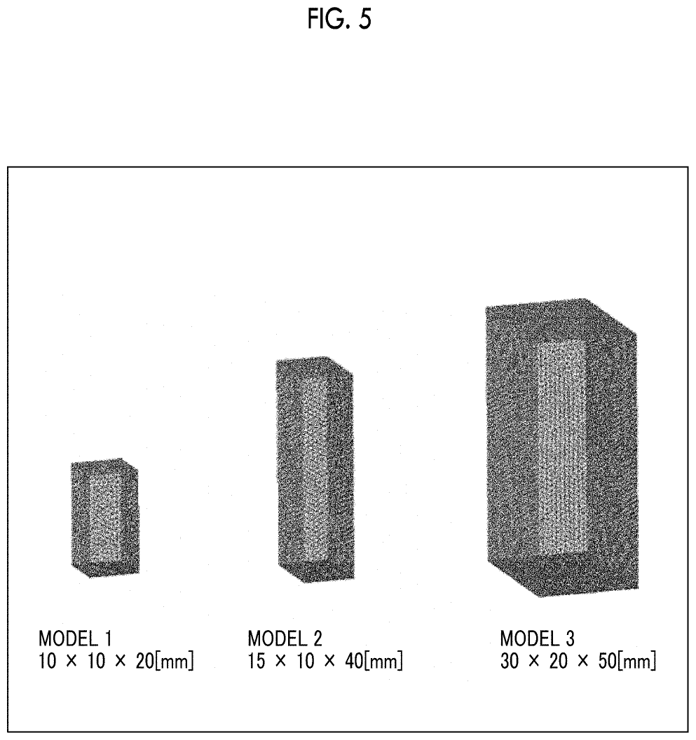

FIG. 5 is a perspective view of three simulation models having different dimensions. All simulation models are rectangular parallelepiped. The length, width, and height of a model 1 are respectively 10 mm, 10 mm, and 20 mm. The length, width, and height of a model 2 are respectively 15 mm, 10 mm, and 40 mm. The length, width, and height of a model 3 are respectively 30 mm, 20 mm, and 50 mm. The bottom surfaces of these simulation models are fixed and a tensile stress is applied to the top surfaces of the models to determine the relationship between the stress and the strain. A·kᵢⱼ in equation (5) is set so as to reproduce a material having a Young's modulus of 208 GPa.

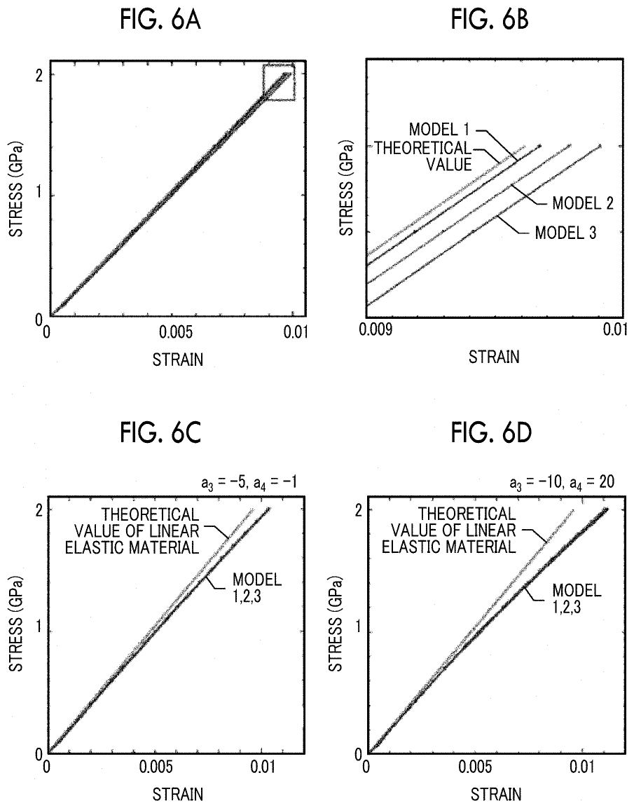

FIGS. 6A and 6B are graphs showing the relationship between the strain and stress of each model when the analysis is performed using the interaction potential where a₃=a₄=0 in equation (5). FIG. 6B is an enlarged graph of a part of FIG. 6A. For reference, a theoretical value of the material having the Young's modulus of 208 GPa is also shown. In any model, it is confirmed that a simulation result substantially close to the theoretical value is obtained.

FIG. 6C is a graph showing a simulation result when a₃=−5 and a₄=−1 in equation (5), and FIG. 6D is a graph showing a simulation result when a₃=−10 and a₄=20 in equation (5). For reference, theoretical values when a tensile stress is applied to the linear elastic material are shown. In any model, it can be understood that nonlinearity appears in the theoretical value of the linear elastic material. It can be understood that the simulation results of the models 1, 2, and 3 match to an extent that the results can hardly be distinguished. Accordingly, it is confirmed that the interaction potential of equation (5) does not depend on the dimension of the simulation model.

In a case where the simulation is performed using the interaction potential shown in equation (5), parameters A, a₃, and a₄ are required to be determined so as to reproduce physical properties of the material to be simulated. However, it is unclear how the parameters of these nonlinear terms affect the relationship between the stress and the strain. Therefore, it is impossible to determine the values of these parameters directly from the physical properties of the material. It is possible to find the values of these parameters, for example, by repeating trial and error. Hereinafter, an example of a procedure for finding optimum values of these parameters will be described. Here, the “optimum value” does not mean an optimum value among all combinations of the values but means a preferable value with which the simulation can be performed with sufficiently high accuracy.

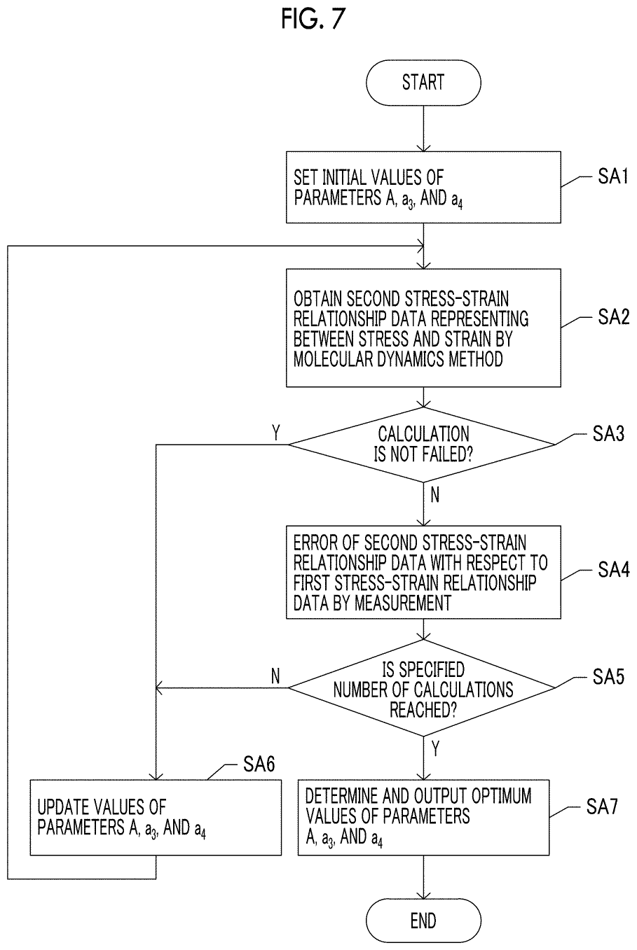

FIG. 7 is a flowchart of a procedure for finding the optimum values of the parameters A, a₃, and a₄ according to the material to be simulated. This procedure is executed by the processing unit 21 of the simulation apparatus shown in FIG. 1. This procedure maybe executed by a computer different from the simulation apparatus.

First, initial values of the parameters A, a₃, and a₄ are set (step SA1). The initial value may be determined from an empirical rule based on, for example, the Young's modulus in a linear deformation region of the nonlinear elastic material to be simulated. Based on the set values of the parameters A, a₃, and a₄, the relationship between the stress and the strain is obtained by the molecular dynamics method using the interaction potential of equation (5) (step SA2). This relationship is referred to as second stress-strain relationship data.

In a case where a calculation fails during the calculation of step SA2 (step SA3), the calculation ends, the values of parameters A, a₃, and a₄ are updated (step SA6), and the process of step SA2 is repeated. Here, the case where the calculation fails means, for example, a case where a calculation for dividing by zero is performed. A maximum value, a minimum value, and a pitch width at the time of the updating of the values of the parameters A, a₃, and a₄ are determined in advance.

In a case where the second stress-strain relationship data is obtained with no failure in the calculation of step SA2, the first stress-strain relationship data representing the measured relationship between the stress and the strain is compared with the second stress-strain relationship data obtained by the calculation. From the comparison, an error of the second stress-strain relationship data with respect to the first stress-strain relationship data is obtained (step SA4).

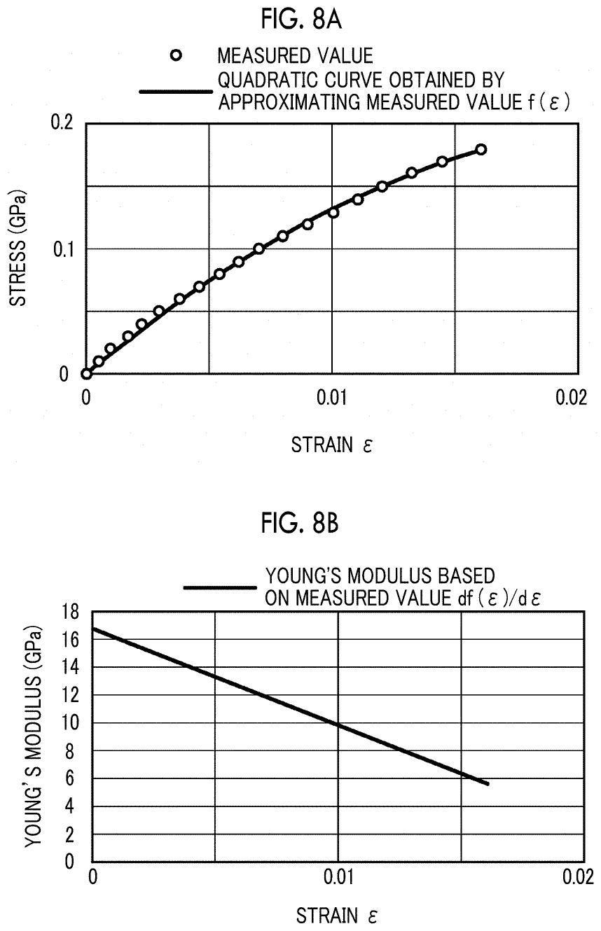

FIG. 8A is a graph showing an example of the first stress-strain relationship data. The horizontal axis represents the strain ε, and the vertical axis represents the stress in the unit “GPa”. In the graph shown in FIG. 8A, a circle symbol indicates a measured value, and a solid line indicates a quadratic curve obtained by approximating the measured value by a quadratic function. The stress is denoted by f (ε) as a function of the strain ε. The first stress-strain relationship data can be defined by the function f (ε).

FIG. 8B is a graph showing the relationship between the Young's modulus and the strain ε determined from the first stress-strain relationship data. The horizontal axis represents the strain ε, and the vertical axis represents the Young's modulus in the unit “GPa”. The Young's modulus is obtained by differentiating the function f (ε) with the strain ε. The relationship between the Young's modulus and the strain ε obtained from the first stress-strain relationship data is referred to as first Young's modulus-strain relationship data.

As the error of the second stress-strain relationship data with respect to the first stress-strain relationship data, for example, it is preferable to adopt a determination coefficient (R₂ value) with the function f (ε) representing the first stress-strain relationship data obtained from the measured value as a regression equation and the second stress-strain relationship data obtained from the calculation result as a sample value. Hereinafter, this determination coefficient is referred to as “the determination coefficient of the stress-strain relationship”.

Further, second Young's modulus-strain relationship data is obtained from the second stress-strain relationship data obtained by the calculation. The second Young's modulus-strain relationship data can be represented, for example, by a ratio of a stress increment to a strain ε increment at two adjacent points of the discrete second stress-strain relationship data. In step SA4, an error of the second Young's modulus-strain relationship data with respect to the first Young's modulus-strain relationship data is obtained together with the error of the second stress-strain relationship data with respect to the first stress-strain relationship data. As this error, it is preferable to adopt a determination coefficient (R₂ value) with a function df(ε)/dε (FIG. 8B) representing the first Young's modulus-strain relationship data obtained from the measured value as a regression equation and the second Young's modulus-strain relationship data obtained from the calculation result as a sample value. Hereinafter, this determination coefficient is referred to as “the determination coefficient of the Young's modulus-strain relationship”.

The processes from step SA2 (FIG. 7) to step SA4 (FIG. 7) and the process of step SA6 (FIG. 7) are repeated until the specified number of calculations is reached (step SA5). When the processes from step SA2 to step SA4 and the process of step SA6 reach the specified number of calculations, the optimum values of the parameters A, a₃, and a₄ are determined and output, based on the comparison result between the first stress-strain relationship data and the second stress-strain relationship data and the comparison result between the first Young's modulus-strain relationship data and the second Young's modulus-strain relationship data (step SA7).

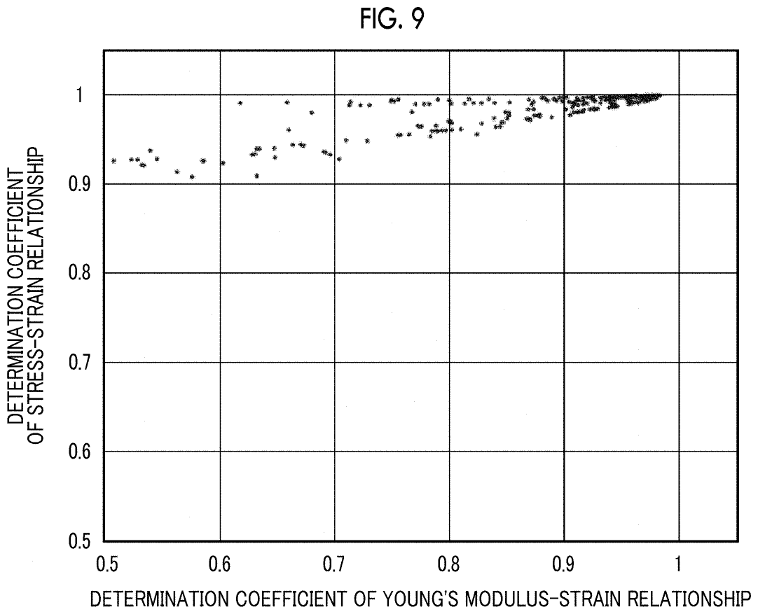

Hereinafter, a method of determining the optimum values of the parameters A, a₃, and a₄ will be described with reference to FIG. 9.

FIG. 9 is a scatter diagram with the determination coefficient of the Young's modulus-strain relationship as the horizontal axis and the determination coefficient of the stress-strain relationship as the vertical axis. The scatter diagram shown in FIG. 9 shows the calculation results when the minimum value, maximum value, and the pitch width of the parameter A are respectively set to 0.01, 0.2, and 0.02, the minimum value, maximum value, and the pitch width of the parameter a₃ are respectively set to −500, 500, and 1.0, and the minimum value, maximum value, and the pitch width of the parameter a₄ are respectively set to −500, 500, and 1.0.

Values of the parameters A, a₃, and a₄ when the determination coefficient of the Young's modulus-strain relationship and the determination coefficient of the stress-strain relationship are the largest are adopted as the optimum values. In the example shown in FIG. 9, the determination coefficient of the Young's modulus-strain relationship is 0.983 and the determination coefficient of the stress-strain relationship is 0.9997 at a point where the optimum values of the parameters A, a₃, and a₄ are provided, and a good match between the calculation result and the measurement result is obtained.

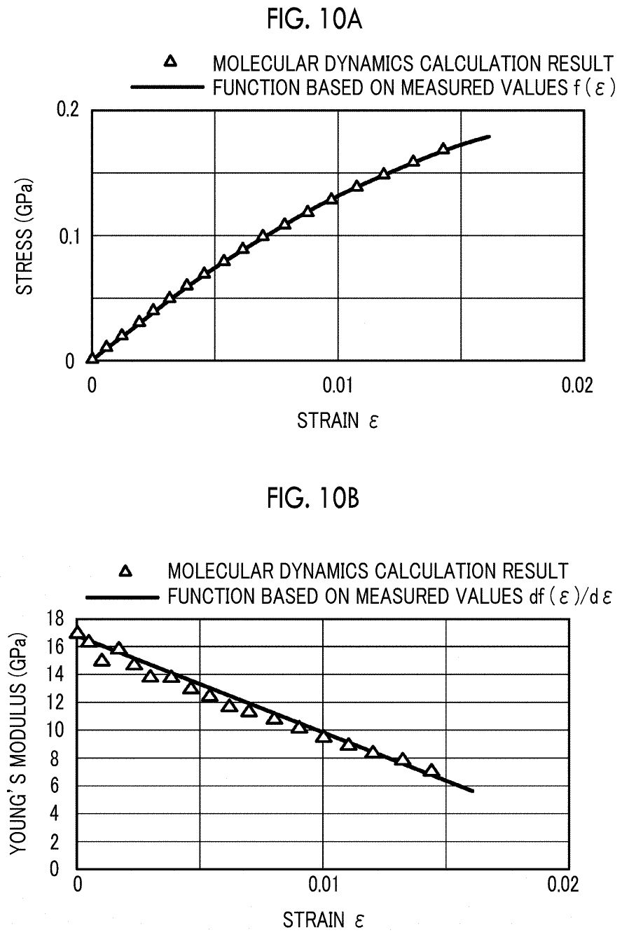

FIG. 10A is a graph showing the second stress-strain relationship data obtained by the molecular dynamics method with the parameters A, a₃, and a₄ set to the optimum values and the first stress-strain relationship data obtained from the measured values. A triangle symbol indicates the second stress-strain relationship data obtained from the calculated value, and a solid line indicates the function f (ε) representing the first stress-strain relationship data based on the measured value.

FIG. 10B is a graph showing the second Young's modulus-strain relationship data obtained by the molecular dynamics method with the parameters A, a₃, and a₄ set to the optimum values and the first Young's modulus-strain relationship data obtained from the measured value. A triangle symbol indicates the second Young's modulus-strain relationship data obtained from the calculated value, and a solid line indicates the function df(ε)/dε representing the first Young's modulus-strain relationship data.

As shown in FIGS. 10A and 10B, it can be understood that the calculated values and the measured values are in a good match. As described above, it is confirmed that the optimum values of the parameters A, a₃, and a₄ with which the simulation can be performed with high accuracy can be determined by the method shown in FIG. 7.

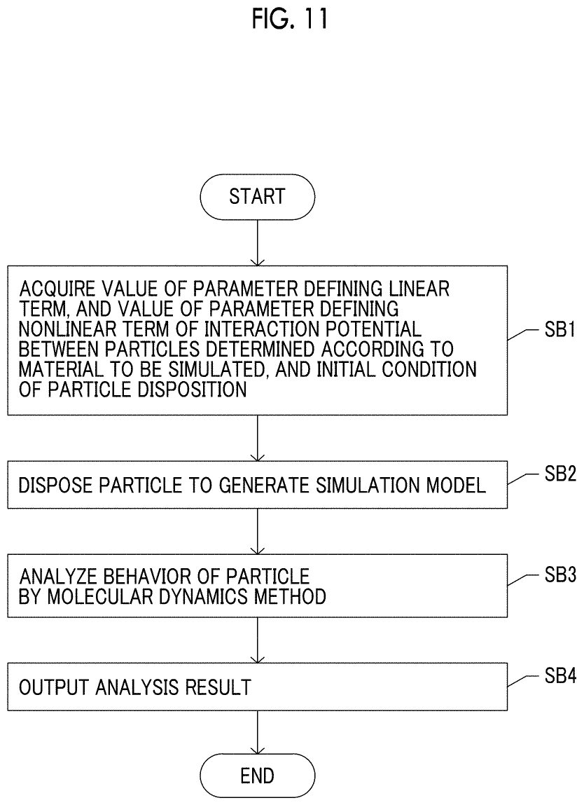

FIG. 11 is a flowchart of a simulation method according to the embodiment. Processes shown in FIG. 11 are executed by the processing unit 21 of the simulation apparatus of this embodiment.

The processing unit 21 acquires the value of the parameter A defining the linear term, the value of the spring constant kᵢⱼ, and the values of the parameters a₃ and a₄ defining the nonlinear terms of the interaction potential between the particles determined according to the material to be simulated, and the simulation condition such as the initial condition of the particle disposition (step SB1). The parameter A and the spring constant kᵢⱼ may be handled as one linear parameter as A·kᵢⱼ. The particle is disposed based on the acquired simulation condition to generate a simulation model (step SB2).

The behavior of the particles is analyzed by the molecular dynamics method using the interaction potentials of equations (4) and (5) based on the input values of the parameter A, the spring constant kᵢⱼ, and the parameters a₃ and a₄ (step SB3). After the analysis, the analysis result is output to the output unit 22 (step SB4). For example, the output unit 22 may display a change in the position of the particle or a change in the shape of the tetra mesh as a graphic in a time series.

Next, an excellent effect of the embodiment will be described. According to this embodiment, it is possible to perform a mechanism analysis in consideration of the nonlinear region of the nonlinear elastic material. Using the parameter optimization method shown in FIG. 7, it is possible to determine the optimum value of the nonlinear parameter according to various nonlinear elastic materials. Accordingly, it is possible to perform the analysis of the mechanism using the various nonlinear elastic material materials.

Next, a modification example of the above embodiment will be described. In the above embodiment, the optimum values of the parameters A, a₃, and a₄ are determined using the determination coefficient of the Young's modulus-strain relationship and the determination coefficient of the stress-strain relationship in step SA7 of FIG. 7. However, the optimum values of the parameters A, a₃, and a₄ may be determined using any one determination coefficient.

As shown in FIG. 9, the determination coefficient of the Young's modulus-strain relationship may be significantly smaller than one even in a case where the determination coefficient of the stress-strain relationship is close to one. When the optimum values of the parameters A, a₃, and a₄ are determined using only the determination coefficient of the stress-strain relationship, there is a high possibility that a point having a small determination coefficient of the Young's modulus-strain relationship is mistakenly recognized as a point where the optimum value is provided. It is possible to avoid such misrecognition by using the determination coefficient of the Young's modulus-strain relationship and the determination coefficient of the stress-strain relationship together.

In the above embodiment, up to the fourth-order nonlinear term is considered as the interaction potential of equation (5), but a higher-order nonlinear term of the fifth-order or more may be considered. In this case, the number of nonlinear parameters increases.

The above embodiment is an example, and the present invention is not limited to the above embodiment. For example, it is apparent to those skilled in the art that various changes, improvements, combinations, and the like can be made.

It should be understood that the invention is not limited to the above-described embodiment, but may be modified into various forms on the basis of the spirit of the invention. Additionally, the modifications are included in the scope of the invention.

What is claimed is:

1. A simulation apparatus comprising:
an input unit that acquires a value of a parameter defining a linear term and a value of a parameter defining a nonlinear term of an interaction potential between particles determined according to a material to be simulated and an initial condition of a particle disposition; and
a processing unit that analyzes behavior of the particles by a molecular dynamics method based on the initial condition acquired by the input unit, using the interaction potential defined by the values of the parameters acquired by the input unit.

2. The simulation apparatus according to claim 1,
wherein the input unit acquires initial values of the parameters and first stress-strain relationship data obtained from measured values of a stress and a strain of the material to be simulated, and
wherein the processing unit obtains second stress-strain relationship data representing a relationship between the stress and the strain for each combination of the values of the parameters by the molecular dynamics method while updating the values of the parameters from the initial values, and determines optimum values of the parameters based on a comparison result between the first stress-strain relationship data and the second stress-strain relationship data.

3. The simulation apparatus according to claim 2,
wherein the processing unit further obtains first Young's modulus-strain relationship data representing a relationship between a Young's modulus and the strain from the first stress-strain relationship data, obtains second Young's modulus-strain relationship data representing a relationship between a Young's modulus and the strain from the second stress-strain relationship data, and determines the optimum values of the parameters based on a comparison result between the first Young's modulus-strain relationship data and the second Young's modulus-strain relationship data.

4. A simulation method comprising:
analyzing behavior of particles by a molecular dynamics method using an interaction potential defined by a value of a parameter defining a linear term and a value of a parameter defining a nonlinear term of the interaction potential between the particles determined according to a material to be simulated, as a simulation condition.

5. The simulation method according to claim 4, comprising:
obtaining second stress-strain relationship data representing a relationship between a stress and a strain for each combination of the values of the parameters by the molecular dynamics method while updating the values of the parameters from initial values before analyzing the behavior of the particles,
determining optimum values of the parameters based on a comparison result between first stress-strain relationship data obtained from measured values of a stress and a strain of the material to be simulated and the second stress-strain relationship data, and
analyzing the behavior of the particles using the optimum values of the parameters.

6. The simulation method according to claim 5, comprising:
obtaining first Young's modulus-strain relationship data representing a relationship between a Young's modulus and the strain from the first stress-strain relationship data,
obtaining second Young's modulus-strain relationship data representing a relationship between a Young's modulus and the strain from the second stress-strain relationship data, and
determining the optimum values of the parameters based on a comparison result between the first Young's modulus-strain relationship data and the second Young's modulus-strain relationship data.

7. A computer readable medium storing a program that causes a computer to execute a process, the process comprising:
a function of analyzing behavior of particles by a molecular dynamics method using an interaction potential defined by a value of a parameter defining a linear term and a value of a parameter defining a nonlinear term of the interaction potential between the particles determined according to a material to be simulated, as a simulation condition.
